(19) United States
(12) Patent Application Publication
(10) Pub. No.: US 2019/0162123 A1
(43) Pub. Date: May 30, 2019

(54) Gas Internal Combustion Engine With Auxiliary Starting System

(71) Applicant: Continental Automotive GmbH, Hannover (DE)

(72) Inventors: Johannes Ante, Regensburg (DE); Markus Hien, Bruck (DE)

(73) Assignee: Continental Automotive GmbH, Hannover (DE)

(21) Appl. No.: 16/313,348

(22) PCT Filed: May 4, 2017
(86) PCT No.: PCT/EP2017/060708

§ 371 Date: Dec. 26, 2018

(30) Foreign Application Priority Data
Jun. 30, 2016 (DE) 10 2016 211 792.0

(51) Int. Cl. F02D 19/06; F02D 19/08; F02D 41/00; F02D 41/06

(52) U.S. Cl. CPC F02D 19/0647; F02D 19/081; F02D 2200/0414; F02D 41/0052; F02D 41/064; F02D 41/0027

(57) ABSTRACT

An internal combustion engine may include: a combustion chamber to burn an air/gas mixture; an intake manifold configured to feed the air/gas fuel mixture to the combustion chamber at specified times for combustion; and an auxiliary starting system for starting the internal combustion engine. The auxiliary starting system comprises: an auxiliary fuel tank to store an auxiliary fuel; a control valve to open or close a connection between the auxiliary fuel tank and the intake manifold; an ambient temperature sensor to produce a signal that indicates an ambient temperature of the gas internal combustion engine; and a control unit to receive the signal from the ambient temperature sensor and to operate the control valve to feed auxiliary fuel from the auxiliary fuel tank into the intake manifold to start the gas internal combustion engine if the ambient temperature is lower than a specified ambient temperature threshold.

### CROSS-REFERENCE TO RELATED APPLICATIONS

This application is a U.S. National Stage Application of International Application No. PCT/EP2017/060708 filed May 4, 2017, which designates the United States of America, and claims priority to DE Application No. 10 2016 211 792.0 filed Jun. 30, 2016, the contents of which are hereby incorporated by reference in their entirety.

### TECHNICAL FIELD

The present disclosure relates to internal combustion engines for vehicles. Various embodiments may include engines operated with natural gas and with an auxiliary starting system, and/or methods for operating a gas internal combustion engine.

### BACKGROUND

To operate a vehicle with natural gas, e.g., compressed natural gas (CNG), an adapted internal combustion engine that burns a natural gas/air mixture is usually used. For correct functioning of the catalytic converter, the engine should burn the natural gas/air mixture stoichiometrically, that is to say that the internal combustion engine is generally controlled in accordance with lambda control, in which the lambda value is preferably 1 when averaged over time.

Normally, an internal combustion engine operated with natural gas is started with a liquid fuel, e.g. gasoline, and is switched to operating exclusively with natural gas only after a short warm-up time if the lambda probe and the lambda control system are operating as desired. Internal combustion engines operated with natural gas therefore have not only a main natural gas tank but also an auxiliary liquid fuel tank, in which the liquid fuel required for starting the internal combustion engine is stored and fed to the combustion chambers in a liquid state.

To enable an internal combustion engine operated with natural gas to be started with natural gas, the composition of the natural gas must be known as accurately as possible to ensure that the internal combustion engine does not emit excessive unwanted pollutants in the first few minutes. Since lambda values are not yet available in the first few minutes of operation, the natural gas/air mixture is produced by means of preset control. Since the natural gas quality is not yet known here, the natural gas/air mixture generally does not have the optimum ratio for combustion. Natural gas is composed of methane, carbon dioxide, nitrogen and proportions of other gases, such as higher hydrocarbons. Furthermore, the flammability of natural gas decreases at low temperatures, e.g. below 5° C. However, it should be ensured that the driver of the vehicle can reliably start the gas internal combustion engine, even at low temperatures.

For this purpose, one approach includes heating the natural gas at least in part to a desired temperature, at which natural gas has a required combustibility, by means of pre-heating systems. Another known practice includes using a starting pilot for internal combustion engines that do not start well, e.g. in the case of old engines after being stationary for a long period, when starting in winter with a weak battery, in the case of lawnmowers or chainsaws. In certain situations, e.g. when a battery is very largely exhausted, a fuel is of low quality or temperatures are extremely low, an ether mixture can be sprayed into the intake tract of the internal combustion engine manually by means of spray cans. Owing to the high flammability of the ether mixture, the internal combustion engine starts immediately and quickly reaches high speeds. Provided that the internal combustion engine and the associated fuel injection and mixture formation system are working to some extent, the engine can continue to be operated with its liquid fuel.

GB 2 437 098 A, for example, discloses a dual fuel engine with respective fuel control systems. U.S. Pat. No. 9,109,498 B2 discloses a gasoline engine with dimethyl ether pilot injection. U.S. Pat. No. 5,526,786 A describes a dual fuel engine with a control system for pilot injection. CN 103 883 414 A discloses an electronic injection device using dimethyl ether and compressed natural gas.

### SUMMARY

The teachings of the present disclosure may enable a gas internal combustion engine which can be started and operated reliably at any time. For example, some embodiments may include a gas internal combustion engine (10) for vehicles, having: at least one combustion chamber, which is designed to receive an air/gas fuel mixture for combustion of same therein, an intake manifold (14), which is fluidically connected to the at least one combustion chamber and is designed to feed the air/gas fuel mixture to the at least one combustion chamber at specified times for combustion, and an auxiliary starting system (30) for starting the gas internal combustion engine (10), wherein the auxiliary starting system (30) has: an auxiliary fuel tank (32), which is designed to store an auxiliary fuel, a control valve (34), which is designed to open or close a connection between the auxiliary fuel tank (32) and the intake manifold (14), an ambient temperature sensor (36), which is designed to produce a signal that indicates the ambient temperature of the gas internal combustion engine (10), and a control unit (38), which is designed to receive the signal from the ambient temperature sensor (36) and to control the control valve (34) in order to open same, with the result that auxiliary fuel is fed from the auxiliary fuel tank (32) into the intake manifold (14) in order to start the gas internal combustion engine (10), if the ambient temperature is lower than a specified ambient temperature threshold.

In some embodiments, there is a crankshaft speed sensor (42), which is designed to produce a signal which indicates the crankshaft speed of a crankshaft of the gas internal combustion engine (10), wherein the control unit (38) is furthermore designed to control the control valve (34) in order to open same until the crankshaft speed is higher than a specified crankshaft speed threshold.

In some embodiments, there is a device for detecting combustibility within the at least one combustion chamber, wherein the control unit (38) is furthermore designed to control the control valve (34) in order to open same during the operation of the gas internal combustion engine (10), with the result that auxiliary fuel is fed from the auxiliary fuel tank (34) into the intake manifold (14) in order to operate the gas internal combustion engine (10), if the detected combustibility is lower than a specified combustibility.

In some embodiments, there is a main gas fuel quality sensor (22), which is designed to produce a signal which indicates the quality of the main gas fuel, wherein the control unit (38) is furthermore designed to control the control valve (34) in order to open same during the operation of the gas internal combustion engine (10), with the result that auxiliary fuel is fed from the auxiliary fuel tank (32) into the intake manifold (14) in order to operate the gas internal combustion engine (10), if the gas fuel quality is outside a specified gas fuel quality range.

In some embodiments, there is an air mass meter (48), which is arranged on the intake manifold (14) and is designed to produce a signal which indicates the combustion air mass flowing into the intake manifold (14), wherein the control unit (38) is designed to adjust the opening time of the control valve (34) in such a way that an auxiliary fuel quantity stoichiometrically required for the combustion air mass flowing into the intake manifold (14) is fed into the intake manifold (14) from the auxiliary fuel tank (32).

In some embodiments, the auxiliary fuel comprises dimethyl ether.

In some embodiments, there is at least one ignition device, which is designed to ignite the air/main gas fuel mixture and/or the air/auxiliary fuel mixture and/or the air/main gas fuel and auxiliary fuel mixture within the at least one combustion chamber.

As another example, some embodiments may include a method for operating a gas internal combustion engine (10) which has at least one combustion chamber, which is designed to receive an air/gas fuel mixture for combustion of same therein, and an intake manifold (14), which is fluidically connected to the at least one combustion chamber and is designed to feed the air/main gas fuel mixture to the at least one combustion chamber at specified times for combustion, wherein the method comprises the following steps: detecting the ambient temperature of the gas internal combustion engine (10), and feeding auxiliary fuel into the intake manifold (14) in order to start the gas internal combustion engine (10) if the ambient temperature is lower than a specified ambient temperature threshold.

In some embodiments, the method further includes detecting the crankshaft speed of a crankshaft of the gas internal combustion engine (10), wherein the auxiliary fuel is fed into the intake manifold (14) until the crankshaft speed is higher than a specified crankshaft speed threshold.

In some embodiments, the method further includes detecting the combustion chamber temperature within the at least one combustion chamber, wherein, during the operation of the gas internal combustion engine, auxiliary fuel is fed into the intake manifold (14) to operate the gas internal combustion engine (10) if the combustion chamber temperature is lower than a specified combustion chamber temperature threshold.

### BRIEF DESCRIPTION OF THE DRAWINGS

Further features and objects of the teachings herein will become apparent to a person skilled in the art by practising the present teaching and taking into consideration the appended drawings, in which:

FIG. 1 shows schematically a gas internal combustion engine incorporating teachings of the present disclosure; and

FIG. 2 shows schematically an illustrative method for operating a gas internal combustion engine, incorporating teachings of the present disclosure.

### DETAILED DESCRIPTION

It can be difficult to start a gas internal combustion engine, which is operated with natural gas, in certain situations, especially at very low temperatures. To enable a gas internal combustion engine of this kind to be started reliably, the teachings herein include, when such a situation is detected, an auxiliary fuel, such as dimethyl ether, is injected into the combustion chambers of the gas internal combustion engine, and the starting of the gas internal combustion engine is thus promoted.

The auxiliary fuel is distinguished by the fact that, although it is stored in the liquid state under pressure, it gasifies when fed into the combustion chambers, that is to say changes to the gaseous state, in which the auxiliary fuel is highly flammable. A gas internal combustion engine incorporating the teachings herein thus has at least one combustion chamber, which is designed to receive an air/gas fuel mixture for combustion of same, an intake manifold, which is fluidically connected to the at least one combustion chamber and is designed to feed the air/gas fuel mixture to the at least one combustion chamber at specified times for combustion, and an auxiliary starting system for starting the gas internal combustion engine. The auxiliary starting system comprises an auxiliary fuel tank, which is designed to store an auxiliary fuel, a control valve, which is designed to open or close a connection between the auxiliary fuel tank and the intake manifold, an ambient temperature sensor, which is designed to produce a signal that indicates the ambient temperature of the gas internal combustion engine, and a control unit, which is designed to receive the signal from the ambient temperature sensor and to control the control valve in order to open same, with the result that auxiliary fuel is fed from the auxiliary fuel tank into the intake manifold in order to start the gas internal combustion engine, if the ambient temperature is lower than a specified ambient temperature threshold.

In some embodiments, the auxiliary fuel may comprise a gas fuel with a higher inflammability than the main gas fuel, by means of which the gas internal combustion engine is operated in the normal mode. The auxiliary fuel is dimethyl ether, for example. In alternative embodiments, the auxiliary fuel can furthermore be gasoline.

In some embodiments, the gas internal combustion engine furthermore has a crankshaft speed sensor, which is designed to produce a signal which indicates the crankshaft speed of a crankshaft of the gas internal combustion engine. In this case, the control unit is furthermore preferably designed to control the control valve in order to open same until the crankshaft speed is higher than a specified crankshaft speed threshold. As soon as the specified crankshaft speed has been reached, the control unit controls the control valve in order to close same, and the supply of auxiliary fuel is interrupted. From this time on, the gas internal combustion engine can be operated exclusively with the main gas fuel. At this time, it can namely be assumed that, with the exceeding of the specified crankshaft speed threshold, an operating state of the internal combustion engine in which the gas internal combustion engine can be operated reliably exclusively with the main gas fuel has been reached.

In some embodiments, the gas internal combustion engine furthermore has a device which is designed to detect the combustibility within the at least one combustion chamber. In this case, the control unit is designed to control the control valve in order to open same during the operation of the gas internal combustion engine, with the result that auxiliary fuel is fed from the auxiliary fuel tank into the intake manifold in order to operate the gas internal combustion engine, if the detected combustibility is lower than a specified combustibility.

The device for detecting the combustibility within the at least one combustion chamber is, for example, a flame ionization sensor, which is designed to detect the ignition section of the ignition device immediately after ignition as an ion flow sensor. If an ion flow is detected in this case, it can be assumed that correct ignition has taken place within the at least one combustion chamber. The device for detecting combustibility can furthermore be a crankshaft speed sensor, which detects the crankshaft speed and, if the crankshaft speed is substantially inconstant, indicates a low combustibility, or can be a cylinder pressure sensor, which indicates the pressure within the at least one combustion chamber and, if the cylinder pressure is outside a specified range, indicates a low combustibility.

With the aid of the combustion chamber temperature sensor, it is possible to monitor whether a desired combustion takes place in each combustion chamber. If the air/gas fuel mixture does not ignite correctly in one of the combustion chambers, this can be detected by means of the combustion chamber temperature sensor, and it is possible to switch to the auxiliary fuel from the main gas fuel during operation, or the auxiliary fuel can be added to the air/main gas fuel in order to promote flammability and thus the operation of the gas internal combustion engine.

In some embodiments, the gas internal combustion engine furthermore has a main gas fuel quality sensor, which is designed to produce a signal which indicates the quality of the main gas fuel. In this case, the control unit is furthermore designed to control the control valve in order to open same during the operation of the gas internal combustion engine, with the result that auxiliary fuel is fed from the auxiliary fuel tank into the intake manifold in order to operate the gas internal combustion engine, if the main gas fuel quality is outside a specified main gas fuel quality range.

In certain operating states, the quality of the main gas fuel is only insufficient or the main gas fuel quality sensor is faulty. In order to be able to continue operating or to start the internal combustion engine reliably in such operating states, the flammable auxiliary fuel can additionally or alternatively be fed into the intake manifold with the aid of the control unit in order to operate or start the gas internal combustion engine.

In some embodiments, the internal combustion engine has an air mass meter, which is arranged on the intake manifold and is designed to produce a signal which indicates the combustion air mass flowing into the intake manifold. The control unit is therefore designed to adjust the opening time of the control valve in such a way that an auxiliary fuel quantity stoichiometrically required for the combustion air mass flowing into the intake manifold is fed into the intake manifold from the auxiliary fuel tank. With a knowledge of the auxiliary fuel quantity fed into the intake manifold, the combustion air mass necessary to achieve this for stoichiometric combustion is determined and set by means of the control unit.

In some embodiments, an ignition device is furthermore provided, which is designed to ignite the air/main gas fuel mixture and/or the air/auxiliary fuel mixture and/or the air/main gas fuel and auxiliary fuel mixture within the at least one combustion chamber. For example, the ignition device can be a spark plug, glow plug or some other ignition device known in the prior art.

In some embodiments, a method includes operating a gas internal combustion engine with at least one combustion chamber, which is designed to receive an air/gas fuel mixture for combustion of same therein, and an intake manifold, which is fluidically connected to the at least one combustion chamber and is designed to feed the air/gas fuel mixture to the at least one combustion chamber at specified times for combustion. The method comprises detecting the ambient temperature of the gas internal combustion engine, and feeding auxiliary fuel into the intake manifold in order to start the gas internal combustion engine if the ambient temperature is lower than a specified ambient temperature threshold.

In some embodiments, detecting the crankshaft speed of a crankshaft of the gas internal combustion engine is envisaged, wherein the auxiliary fuel is fed into the intake manifold until the crankshaft speed is higher than a specified crankshaft speed threshold.

In some embodiments, the method furthermore comprises detecting the combustion chamber temperature within the at least one combustion chamber. In this case, during the operation of the gas internal combustion engine, auxiliary fuel is then fed into the intake manifold to operate the gas internal combustion engine if the combustion chamber temperature is lower than a specified combustion chamber temperature threshold. It is thus possible to respond rapidly to ignition conditions that are unfavorable to the main gas fuel during the operation of the internal combustion engine by feeding the flammable auxiliary fuel to the at least one combustion chamber.

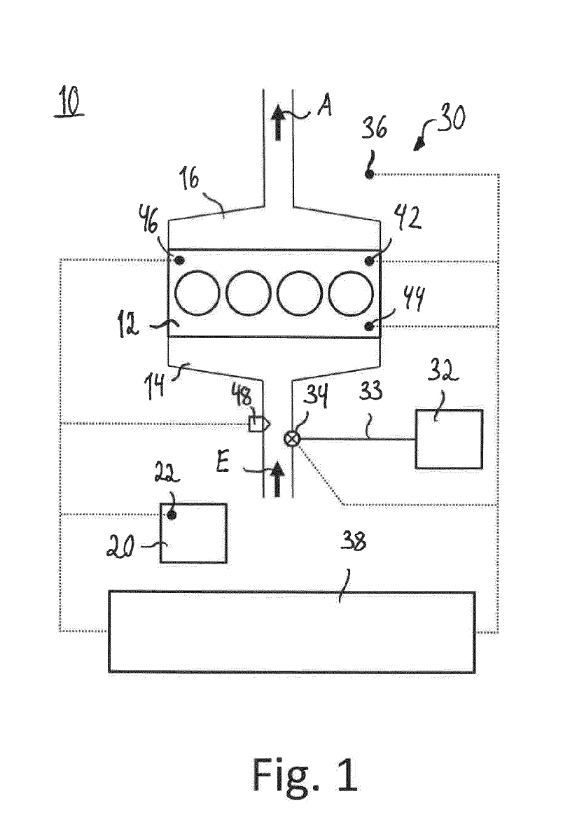

The gas internal combustion engine 10 illustrated schematically in FIG. 1 has an engine block 12 with combustion chambers formed therein (not illustrated explicitly). An intake manifold 14 and an outlet manifold 16 are furthermore provided. The intake manifold is designed to feed an air/gas fuel mixture to each of the combustion chambers. The combustion air is fed to the intake manifold 14 via an air filter (not illustrated explicitly). The main gas fuel comes from a main gas fuel tank 20, which is fluidically connected to the intake manifold 14 and, by means of a control valve, can feed a specified quantity of main gas fuel, e.g. natural gas, to the intake manifold 14 for combustion. In FIG. 1, the flow direction of the air/gas fuel mixture within the intake manifold 14 is indicated by an arrow E. Moreover, the flow direction of the exhaust gas in the outlet manifold 16 is indicated in FIG. 1 by means of the arrow A.

The gas internal combustion engine 10 in FIG. 1 furthermore has an auxiliary starting system 30 for starting the gas internal combustion engine 10. The auxiliary starting system 30 has an auxiliary fuel tank 32, which is designed to store an auxiliary fuel, a control valve 34, which is designed to open or close a connection between the auxiliary fuel tank 32 and the intake manifold 14, an ambient temperature sensor 36, which is designed to produce a signal which indicates the ambient temperature of the gas internal combustion engine 10, and a control unit 38.

In some embodiments, the auxiliary fuel tank 32 is fluidically connected to the intake manifold 14 by means of a connecting line 33. Here, the control valve 34 may be arranged in the connecting line 33 and is designed to open and close the connecting line 33. For example, the control valve 34 may comprise a magnetically actuated injection valve for the continuous adjustment of the auxiliary fuel quantity fed into the intake manifold 14, which is injected in the liquid state under pressure and gasifies when injected. By means of the opening cross section and the pressure of the auxiliary fuel, it is possible to determine the mass flow rate, which can be controlled by means of the injection timing. The shorter the injection time, the smaller is the quantity of auxiliary fuel fed into the intake manifold 14. To feed the auxiliary fuel into the intake manifold 14, an auxiliary fuel pump (not shown explicitly) can be provided, which pumps the auxiliary fuel stored under pressure in the auxiliary fuel tank 20 in the liquid state.

In some embodiments, the ambient temperature sensor 36 is arranged at a position at which the ambient temperature of the gas internal combustion engine 10 or of the vehicle in which the gas internal combustion engine 10 is arranged is to be detected. The auxiliary starting systems 30 in FIG. 1 furthermore has a crankshaft speed sensor 42, which is designed to produce a signal which indicates the crankshaft speed of a crankshaft of the gas internal combustion engine 10, a combustion chamber temperature sensor 44, which is designed to produce a signal which indicates the combustion chamber temperature within the at least one combustion chamber, and a coolant temperature sensor 46, which is designed to produce a signal which indicates the coolant temperature of the coolant circulating in the engine block 12.

In some embodiments, the gas internal combustion engine 10 furthermore has an air mass meter 48, which is designed to produce a signal which indicates the combustion air mass flowing into the intake manifold 14. The gas internal combustion engine 10 in figure furthermore has a main gas fuel quality sensor 22, which is designed to detect the quality of the main gas fuel stored in the main gas fuel tank 20.

FIG. 1 schematically illustrates that the ambient temperature sensor 36, the crankshaft speed sensor 42, the combustion chamber temperature sensor 44, the coolant temperature sensor 46, the air mass meter 48 and the gas fuel quality sensor 22 are connected by suitable means to the control unit 38 and can thus each transmit the individual signals to the control unit 38. The control unit 38, in turn, is designed to receive the individual signals of the respective sensors and to at least partially process them. The control unit 38 can be a separate control unit or can be integrated into the engine controller of the vehicle.

The control valve 34 is furthermore connected to the control unit 38. The control unit 38 can control the control valve 34 in order to open or close same by transmitting a corresponding signal.

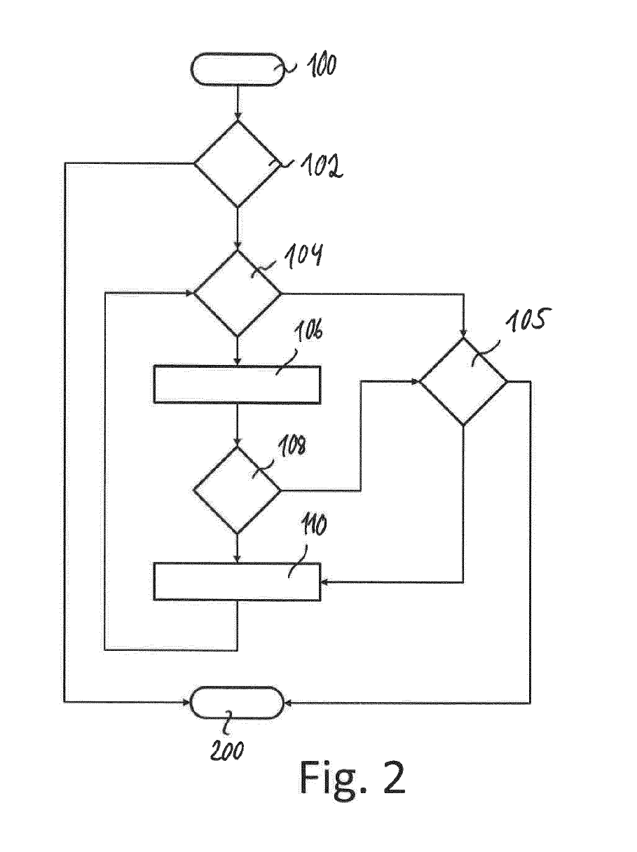

Illustrative operation of the gas internal combustion engine 10, in particular before a start of the gas internal combustion engine 10, is described below with additional reference to FIG. 2. The method according to FIG. 2 begins with step 100 and then passes to step 102, in which the system enquires whether an ignition key of the vehicle has been inserted. If it is determined in step 102 that no ignition key has been inserted, the method passes to step 200 and is ended there.

If, however, it is determined in step 102 that an ignition key has been inserted, the method passes to step 104, in which the system enquires whether the crankshaft speed is below a crankshaft speed threshold. Since the gas internal combustion engine 10 has not yet been started at this time, it can be assumed at this point that the crankshaft speed in step 104 is lower than the specified crankshaft speed threshold.

In this case, the method passes to step 106, and the respective signals of the sensors 22, 36, 42, 44, 46, 48 (see FIG. 1) are received by the control unit 38 and at least partially processed.

In the subsequent step 108, the system enquires, for example, whether the ambient temperature is lower than a specified ambient temperature threshold, e.g. −5° C. In particular, the specified ambient temperature threshold is chosen in such a way that, if this threshold is undershot, reliable starting of the gas internal combustion engine with the main gas fuel from the gas fuel tank 20 cannot be guaranteed. If the ambient temperature is higher than the specified ambient temperature threshold, the method passes to step 105.

If, however, it is determined in step 108 that the ambient temperature is lower than the specified ambient temperature threshold, the method passes to step 110, and the control unit 38 controls the control valve 34 in order to open same. In this case, auxiliary fuel is fed to the intake manifold 14 from the auxiliary fuel tank 32, leading directly to the auxiliary fuel being passed into the combustion chambers. Since the auxiliary fuel is more inflammable than the main gas fuel from the main gas fuel tank 20, the gas internal combustion engine 10 can be reliably started.

After step 110, the method returns to step 104, in which the system enquires whether the crankshaft speed is still below the crankshaft speed threshold. The supply of auxiliary fuel should namely continue until the crankshaft speed exceeds the specified crankshaft speed threshold.

If it is determined in step 104 that the crankshaft speed is higher than the crankshaft speed threshold, the method passes to step 105, in which the crankshaft speed is further evaluated. At this point, the parameters of the gas internal combustion engine 10 which are indicated by the signals of sensors 22, 44, 46 and 48, in particular the combustion chamber temperature, are evaluated.

In some embodiments, during the operation of the gas internal combustion engine, that is to say after a successful start of the gas internal combustion engine, if it is ascertained that the combustions within the combustion chambers are no longer optimum (step 105), it is possible to switch from operation exclusively with main gas fuel to partial or exclusive operation with auxiliary fuel (step 110) to ensure that the gas internal combustion engine 10 gets back into a desired operation with a desired crankshaft speed.

If it is determined in step 105 that all the parameters are correct, the method passes to step 200 and is ended. At this point of the method, the control valve 34 is closed again, and a switch is made to operation exclusively with gas fuel.

What is claimed is:

1. An internal combustion engine comprising:
a combustion chamber to burn an air/gas fuel mixture;
an intake manifold fluidically connected to the combustion chamber and configured to feed the air/gas fuel mixture to the combustion chamber at specified times for combustion;
an auxiliary starting system for starting the internal combustion engine, wherein the auxiliary starting system comprises:
an auxiliary fuel tank to store an auxiliary fuel;
a control valve to open or close a connection between the auxiliary fuel tank and the intake manifold;
an ambient temperature sensor to produce a signal that indicates an ambient temperature of the gas internal combustion engine; and
a control unit to receive the signal from the ambient temperature sensor and to operate the control valve to feed auxiliary fuel from the auxiliary fuel tank into the intake manifold to start the gas internal combustion engine if the ambient temperature is lower than a specified ambient temperature threshold.

2. The internal combustion engine as claimed in claim 1, further comprising a crankshaft speed sensor to produce a signal corresponding to a rotational speed of a crankshaft;
wherein the control unit opens the control valve until the crankshaft speed is higher than a specified crankshaft speed threshold.

3. The internal combustion engine as claimed in claim 1, further comprising sensor for detecting combustibility within the combustion chamber;
wherein the control unit opens the control valve to feed auxiliary fuel from the auxiliary fuel tank into the intake manifold if the detected combustibility is lower than a specified combustibility.

4. The internal combustion engine as claimed in claim 1, further comprising a main gas fuel quality sensor, to produce a signal indicating a quality of the main gas fuel;
wherein the control unit opens the control valve to feed auxiliary fuel from the auxiliary fuel tank into the intake manifold if the gas fuel quality is outside a specified gas fuel quality range.

5. The internal combustion engine as claimed in claim 1, further comprising an air mass meter, arranged on the intake manifold to produce a signal indicating a combustion air mass flowing into the intake manifold;
wherein the control unit adjusts an opening time of the control valve to feed an auxiliary fuel quantity stoichiometrically required for the combustion air mass flowing into the intake manifold into the intake manifold from the auxiliary fuel tank.

6. The internal combustion engine as claimed in claim 1, wherein the auxiliary fuel comprises dimethyl ether.

7. The internal combustion engine as claimed in claim 1, further comprising an ignition device to ignite the air/fuel mixture within the combustion chamber.

8. A method for operating an internal combustion engine with a combustion chamber burning an air/gas fuel mixture and an intake manifold fluidically connected to the combustion chamber and feeding the air/gas fuel mixture to the combustion chamber at specified times for combustion, the method comprising:
detecting an ambient temperature of the internal combustion engine; and
feeding auxiliary fuel into the intake manifold to start the gas internal combustion engine if the ambient temperature is lower than a specified ambient temperature threshold.

9. The method as claimed in claim 8, further comprising:
detecting a rotational speed of a crankshaft of the internal combustion engine; and
feeding the auxiliary fuel into the intake manifold until the rotational speed is higher than a specified crankshaft speed threshold.

10. The method as claimed in claim 8, further comprising:
detecting a combustion chamber temperature within the combustion chamber; and
during the operation of the gas internal combustion engine, feeding auxiliary fuel into the intake manifold if the combustion chamber temperature is lower than a specified combustion chamber temperature threshold.
